(19) United States
(12) Patent Application Publication
(10) Pub. No.: US 2006/0006567 A1
(43) Pub. Date: Jan. 12, 2006

(54) Method for manufacturing an anti-microbial shoe pad

(76) Inventors: Rocky Shih, Taichung City (TW); David Hao, Pingtung County (TW)

Correspondence Address: CHARLES E. BAXLEY, ESQ., 90 JOHN STREET, THIRD FLOOR, NEW YORK, NY, 10038, US

(21) Appl. No.: 10/890,438

(22) Filed: Jul. 12, 2004

(51) Int. Cl. B29C 44/04

(52) U.S. Cl. 264/45.1; 264/321; 264/138

(57) ABSTRACT

The present invention relates to a method for manufacturing an anti-microbial shoe pad, which includes the steps of 1. first step of raw material preparation 10; 2. second step of raw material preparation 20; 3. blending process 30; 4. foaming process 40; and 5. cutting into shape.

### BACKGROUND OF THE INVENTION

1. Field of the Invention

The present invention relates to a method for manufacturing a shoe pad, and more particularly to a process for manufacturing an anti-microbial shoe pad having the steps of: 1. first step of raw material preparation; 2. second step of raw material preparation; 3. blending process; 4. foaming process; and 5. cutting into shape.

2. Description of the Prior Arts

Shoe will emit an unpleasant smell after a certain time of usage, people has to clean and wash it after a regular time. However, the smell comes again after another certain time of use. It is a headache for people to get rid of the smell.

The shoe pad, as an indispensable part of the shoe, is conventionally made of TDI material (toluene diisocyanate) by foaming process, and the TDI has toxicity. Thereby, the manufacturing method for making the shoe pad will endanger the worker's health.

Furthermore, a light shoe can make the user feel comfortable when walking. However, the shoe pad also affects weight of a shoe, besides being decided by the raw material of the shoe. Therefore, to manufacture a light shoe pad has become one of motivations of the present invention.

The present invention has arisen to mitigate and/or obviate the afore-described disadvantages of a conventional shoe pad.

### SUMMARY OF THE INVENTION

The primary object of the present invention is to provide a method for manufacturing an anti-microbial shoe pad capable of deodorizing the smell of a shoe.

The secondary object of the present invention is to provide a method for manufacturing an anti-microbial shoe pad that can prevent positioning being caused during manufacturing process.

The third object of the present invention is to provide a method for manufacturing an anti-microbial shoe pad, which can produce a light shoe pad.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a block flowchart of a method for manufacturing an anti-microbial shoe pad in accordance with the present invention;

FIG. 2 is an illustrative view in accordance with the present invention for showing a first and second step of the manufacturing method;

FIG. 3 is an illustrative view in accordance with the present invention for showing a third step of the manufacturing method;

FIG. 4 is a shoe pad in accordance with the present invention;

FIG. 5 is a shoe pad, in accordance with the present invention, at the top surface of which is laminated with fabric.

### DETAILED DESCRIPTION OF THE PREFERRED EMBODIMENT

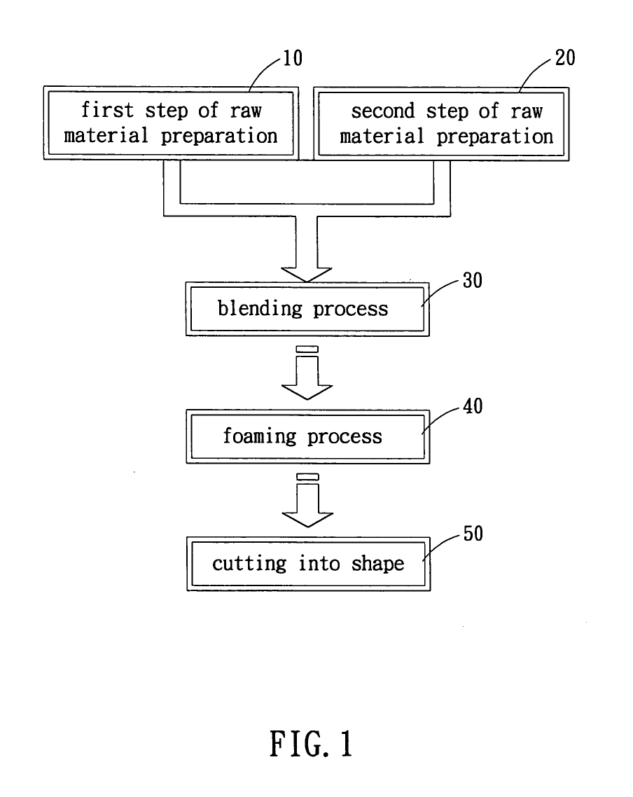

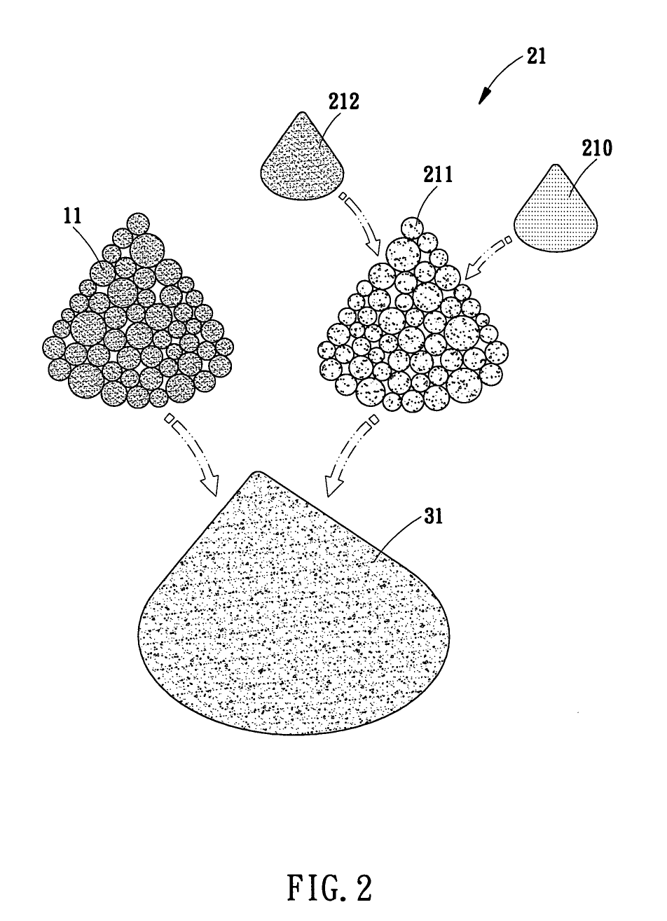

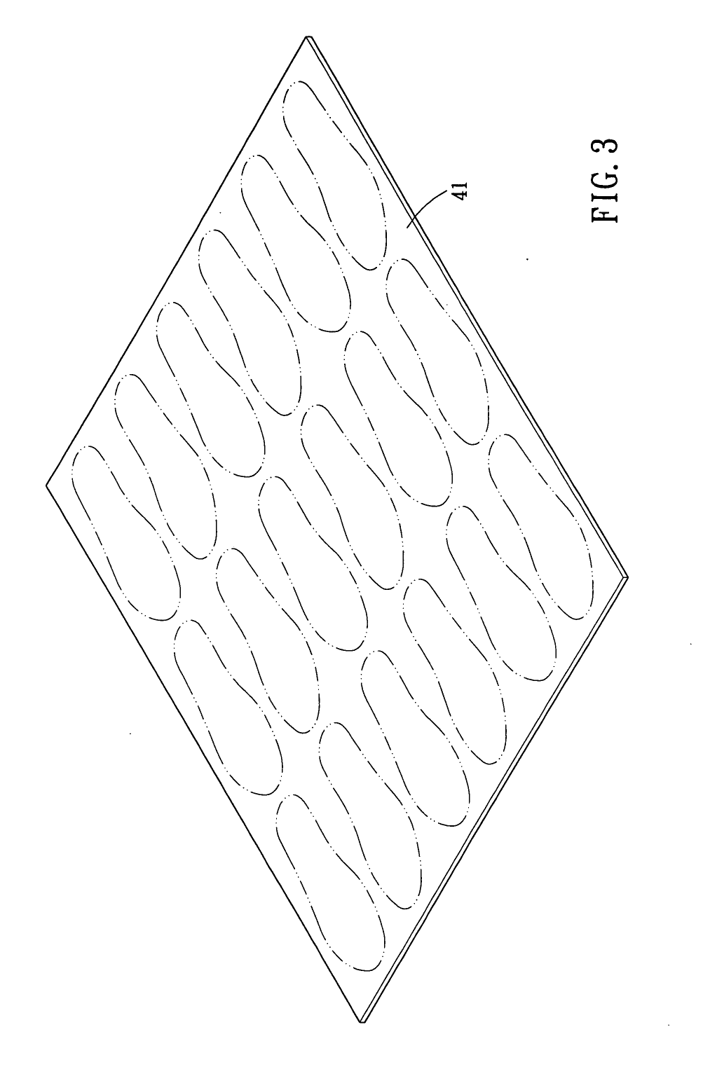

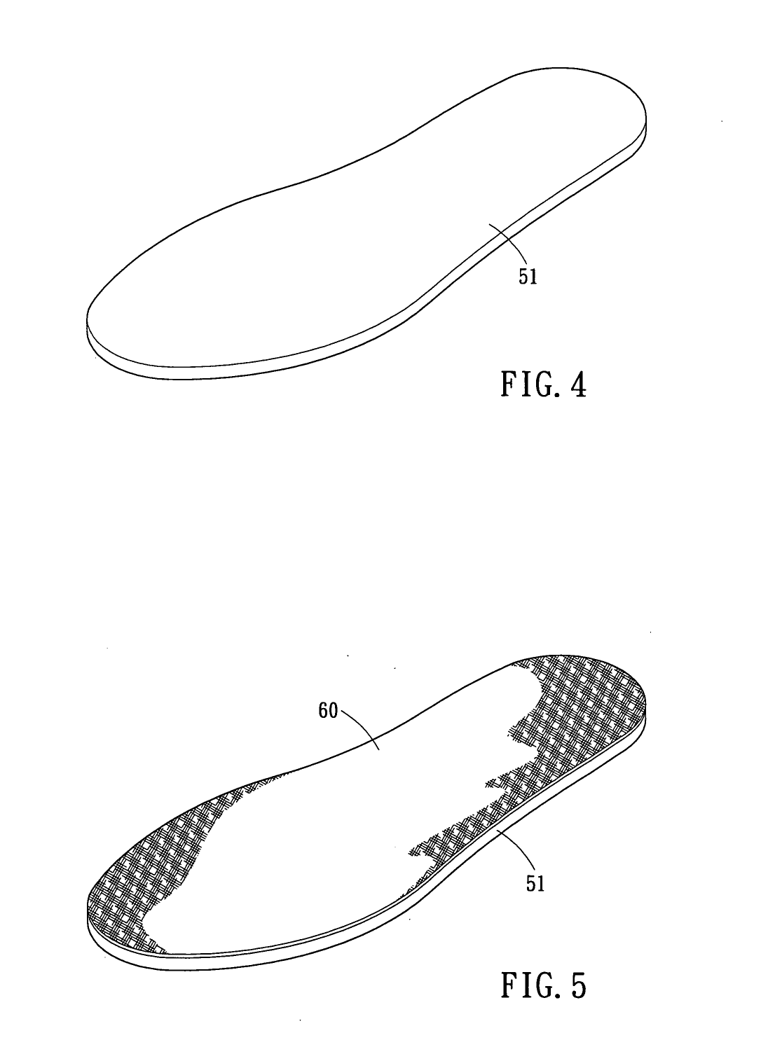

Referring to FIG. 1, a method for manufacturing a shoe pad having anti-microbial properties in accordance with the present invention is shown and generally comprising the following steps: 1. first step of raw material preparation 10; 2. second step of raw material preparation 20; 3. blending process 30; 4. foaming process 40; and 5. cutting into shape.

The above-mentioned steps are illustrated in detail as follows:
1. first step of raw material preparation 10: providing a prepolymer resin as a first material 11 which is synthesized by MDI (Methylene diphenyl diisocyanate) and polyatomic alcohol, the polyatomic alcohol includes Polyester Polyol and polyether polyol.
2. second step of raw material preparation 20: providing a powder product as a second material 21 which is blended by mixed polyatomic alcohol 210, plastic wastes 211 and anti-microbial powder 212, the mixed polyatomic alcohol 210 is mixed by polyatomic alcohol, addition agent and catalysis, the plastic wastes 211 comprises the foaming materials, like: polyurethane, EVA (ethylene vinyl acetate), rubber, the plastic wastes 211 will be pulverized, the anti-microbial powder 212 is Chinese herbal anti-microbial powder, the weight of the second material 21 is made up of 95-99.5% plastic wastes 211 and 0.05-5% anti-microbial powder 212.
3. blending process 30: producing a foaming material 31 by blending 10-60% (weight percentage of) the first material 11 with 50-100% (weight percentage of) the second material 21.
4. 4) foaming process 40: producing a foamed member 41 by foaming the foaming material 31;
5. 5) cutting into shape 50: getting a shoe pad 51 by cutting the foamed member 41 into the shape of a shoe pad.

The process for manufacturing a shoe pad in accordance with the present invention has the advantages as follows:

First, since the shoe pad made based on the process of the present invention contains anti-microbial powder (the herbal anti-microbial powder), besides sterilizing the bacteria and the microbial from the recovery wastes (the plastic wastes), the anti-microbial powder further can improve the breath ability of the shoe pad and make the wearer's feet feel breathable and comfortable. Thus, the shoe pad will not have an unpleasant smell after a certain time of use.

Second, since the first material contains MDI, and the toxicity of MDI is lower than that of TDI, besides improving the physical character of the shoe pad, the present invention provides a safe and relative low-toxicity work surrounding.

Third, the second material (the mixed polyatomic alcohol, the plastic wastes and the anti-microbial powder) is low density, therefore, the shoe pad is relatively lighter than the conventional shoe pad.

Fourth, the second material includes the mixed polyatomic alcohol, the plastic wastes and the anti-microbial powder. The plastic wastes can improve the effect of plastic recovery system. Furthermore, Is the anti-microbial powder doesn't contain heavy metal and can be discomposed naturally. Thus, the shoe pad in accordance with the present invention is of benefit to environmental protection.

It is to be noted that, as shown in FIG. 5, the top surface of the formed member can be provided with a fabric 60 by adhering method or by hot pressing.

While we have shown and described various embodiments in accordance with the present invention, it should be clear to those skilled in the art that further embodiments may be made without departing from the scope of the present invention.

What is claimed is:

1. A method for manufacturing an anti-microbial shoe pad comprising the following steps:
1) first step of raw material preparation: providing a prepolymer resin as a first material which containing MDI (methylene diphenyl diisocyanate);
2) second step of raw material preparation: providing a mixed powder product as a second material which is mixed by mixed polyatomic alcohol, plastic wastes and anti-microbial powder;
3) blending process: blending 10-60% (weight percentage of) the first material with 50-100%(weight percentage of) the second material;
4) foaming process: producing a foamed member by forming the first and the second material;
5) cutting into shape: getting a shoe pad by cutting the foamed member into the shape of a shoe pad.

2. The method for manufacturing an anti-microbial shoe pad as claimed in claim 1, wherein prepolymer resin comprises MDI and polyatomic alcohol.

3. The method for manufacturing an anti-microbial shoe pad as claimed in claim 2, wherein the polyatomic alcohol includes Polyester Polyol and polyether polyol.

4. The method for manufacturing an anti-microbial shoe pad as claimed in claim 1, wherein the mixed polyatomic alcohol is mixed by polyatomic alcohol, addition agent and catalysis.

5. The method for manufacturing an anti-microbial shoe pad as claimed in claim 1, wherein weight percentage of the second material is made up of 95-99.5% plastic wastes and 0.05-5% anti-microbial powder.

6. The method for manufacturing an anti-microbial shoe pad as claimed in claim 1, wherein the anti-microbial powder is herbal anti-microbial powder.

7. The method for manufacturing an anti-microbial shoe pad as claimed in claim 5, wherein the anti-microbial powder is herbal anti-microbial powder.

8. The method for manufacturing an anti-microbial shoe pad as claimed in claim 1, wherein the plastic wastes comprises foaming materials of polyurethane, EVA (ethylene vinyl acetate) and rubber.

9. The method for manufacturing an anti-microbial shoe pad as claimed in claim 1, wherein a fabric is provided on top surface of the foamed member.

10. The method for manufacturing an anti-microbial shoe pad as claimed in claim 9, wherein the fabric is adhered to the top surface of the foamed member.

11. The process for manufacturing an anti-microbial shoe pad as claimed in claim 9, wherein the fabric is pressed on the top surface of the foamed member by hot pressing.
